(19) United States
(12) Patent Application Publication
(10) Pub. No.: US 2020/0410635 A1
(43) Pub. Date: Dec. 31, 2020

(54) CONSISTENTLY EDITING LIGHT FIELD DATA

(71) Applicant: INTERDIGITAL CE PATENT HOLDINGS, Paris (FR)

(72) Inventors: Kiran VARANASI, SAARBRUECKEN (DE); Neus SABATER MUNOZ, BETTON (FR); Francois LE CLERC, L'HERMITAGE (FR)

(21) Appl. No.: 16/068,676

(22) PCT Filed: Jan. 4, 2017
(86) PCT No.: PCT/EP2017/050138

§ 371 Date: Jul. 8, 2018

(30) Foreign Application Priority Data
Jan. 11, 2016 (EP) 16305017.2

(51) Int. Cl. G06T 3/00; G06T 15/20

(52) U.S. Cl. CPC G06T 3/0031; G06K 2009/2045; G06T 15/205

(57) ABSTRACT

The invention describes a method for applying a geometric warp to the light field capture of a 3D scene, consisting of several views of the scene taken from different viewpoints. The warp is specified as a set of (source point, target point) positional constraints on a subset of the views. These positional constraints are propagated to all the views and a warped image is generated for each view, in such a way that these warped images are geometrically consistent in 3D across the views.

### 1. TECHNICAL FIELD

The field of the disclosure relates to light-field imaging. More particularly, the disclosure pertains to technologies for editing images of light field data.

### 2. BACKGROUND ART

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Conventional image capture devices render a 3 (three)-dimensional (3D) scene onto a two-dimensional sensor. During operation, a conventional capture device captures a two-dimensional (2D) image representing an amount of light that reaches each point on a sensor (or photo-detector) within the device. However, this 2D image contains no information about the directional distribution of the light rays that reach the sensor (may be referred to as the light-field). Depth, for example, is lost during the acquisition. Thus, a conventional capture device does not store most of the information about the light distribution from the scene.

Light-field capture devices (also referred to as “light-field data acquisition devices”) have been designed to measure a four-dimensional (4D) light field of the scene by capturing the light from different viewpoints of that scene. Thus, by measuring the amount of light traveling along each beam of light that intersects the sensor, these devices can capture additional optical information (information about the directional distribution of the bundle of light rays) for providing new imaging applications by post-processing. The information acquired/obtained by a light-field capture device is referred to as the light-field data. Light-field capture devices are defined herein as any devices that are capable of capturing light-field data.

There are several groups of light-field capture devices.

A first group of light-field capture devices, also referred to as “camera array”, embodies an array of cameras that project images onto a single shared image sensor or different image sensors. These devices require therefore an extremely accurate arrangement and orientation of cameras, which make their manufacturing often complex and costly.

A second group of light-field capture devices, also referred to as “plenoptic device” or “plenoptic camera”, embodies a micro-lens array positioned in the image focal field of a main lens, and before a photo-sensor on which one micro-image per micro-lens is projected. Plenoptic cameras are divided in two types depending on the distance d between the micro-lens array and the sensor. Regarding the “type 1 plenoptic cameras”, this distance d is equal to the micro-lenses focal length f (as presented in the article “Light-field photography with a hand-held plenoptic camera” by R. Ng et al., CSTR, 2(11), 2005). Regarding the “type 2 plenoptic cameras”, this distance d differs from the micro-lenses focal length f (as presented in the article “The focused plenoptic camera” by A. Lumsdaine and T. Georgiev, ICCP, 2009). For both type 1 and type 2 plenoptic cameras, the area of the photo-sensor under each micro-lens is referred to as a microimage. For type 1 plenoptic cameras, each microimage depicts a certain area of the captured scene and each pixel of this microimage depicts this certain area from the point of view of a certain sub-aperture location on the main lens exit pupil. For type 2 plenoptic cameras, adjacent microimages may partially overlap. One pixel located within such overlaying portions may therefore capture light rays refracted at different sub-aperture locations on the main lens exit pupil.

Light-field data processing comprises notably, but is not limited to, generating refocused images of a scene, generating perspective views of a scene, generating depth maps of a scene, generating extended depth of field (EDOF) images, generating stereoscopic images, and/or any combination of these.

Despite the increasing interest in light field capture, few editing techniques are available for editing light field data consistently across viewpoints. Most of the proposed methods (as illustrated by the article “Plenoptic Image Editing” by S. Seitz and K. M. Kutulakos, in International Conference on Computer Vision, 1998.) deal with editing texture information, but few are able to change the geometry of the images. Such a geometric warping of the image can be used for magnifying or compressing certain image regions. For example, the window of a captured building in an image can be made bigger in size, or the chest of a person in the image can be made bigger in order to give a more muscular appearance.

Specifically, a convenient and efficient method for editing conventional 2D images relies on sparse positional constraints, consisting of a set of pairs of a source point location, and a target point location. Each pair enforces the constraint that the pixel at the location of the source point in the original image should move to the location of the corresponding target point in the result image. The change in image geometry is obtained by applying a dense image warping transform to the source image. The transform at each image point is obtained as the result of a computation process that optimizes the preservation of local image texture features, while satisfying the constraints on sparse control points.

Such an image warping method cannot be applied directly to individual views in a light field, because this will result in misalignment in the views and produce jarring visual artefacts.

It would hence be desirable to provide an apparatus and a method that show improvements over the background art.

### 3. SUMMARY OF THE DISCLOSURE

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A particular embodiment of the invention pertains to a method for consistently editing light field data, the method processing:
the light field data that comprise a plurality of calibrated 2D images of a 3D scene depicted from a set of 2D views, the set of 2D views comprising at least two reference views and at least one additional view,
at least one initial set of positional constraint parameters associated with the at least two reference views, each of the positional constraint parameters representing a transformation to be applied to a given point in an original 2D image of the 3D scene depicted from a corresponding view, among the at least two reference views, to warp said original 2D image, the positional constraint parameters comprising:
   a 2D source location in the corresponding view, of the given point in the original 2D image of the 3D scene depicted from the corresponding view,
   a 2D target location in the corresponding view, of the given point in a warped 2D image of the 3D scene depicted from the corresponding view,
      the method comprising:
determining for each of the positional constraint parameters associated with the at least two reference views, a 3D source location, in the 3D scene, of which the 2D source location is the projection into the corresponding view, and a 3D target location, in the 3D scene, of which the 2D target location is the projection into the corresponding view,
determining an additional set of additional positional constraint parameters, associated with the at least one additional views, as a function of the 3D source location and the 3D target location, each of the additional positional constraint parameters representing a transformation to be applied to a given point in an original 2D image of the 3D scene depicted from a corresponding view, among the at least one additional view, to warp said original 2D image,
warping each of the 2D images of the 3D scene depicted from the set of 2D views, as a function of the positional constraint parameters associated with the 2D views, to obtain the edited light field data.

In the present description, the terms “calibrated 2D views” refer to bi-dimensional views of which the corresponding matrix of projection of the 3D scene is known. Such a matrix of projection allows determining the projection into the 2D view of any point in 3D space. Conversely, given some point on the image of a 2D view, the projection matrix allows determining the viewing ray of this view, i.e. the line in 3D space that projects onto said point. Besides, by warping each of the 2D images, one should understand warping the set of 2D views comprising at least two reference views and at least one additional view as a function of their respective corresponding initial and additional positional constraint parameters.

The invention relies on a new and inventive approach of generalization of an image warping method to light field data. Such a method allows propagating a geometric warp specified by positional constraint parameters on some of the views of a light-field capture, referred to under the terms “reference views”, to additional views for which such positional constraint parameter are not initially specified. The method then allows generating a warped image for each view of the light field capture, in such a way that the warped images are geometrically consistent in 3D across the views. The set of all the warped images corresponds to the edited light field data.

In one particular embodiment, the plurality of calibrated 2D images of the 3D scene is further depicted from a set of corresponding matrices of projection (Cₘ) of the 3D scene for each of the 2D views (Vₘ) known as calibration data.

In one particular embodiment, the method comprises a prior step of inputting the at least one initial set of positional constraint parameters.

In one embodiment, a user inputs such initial set of positional constraint parameters by means of a Human/Machine interface.

In one particular embodiment, the method comprises determining, for each of the positional constraint parameters associated with the reference views, a line in 3D space that projects on the 2D source location, and a line in 3D space that projects on the 2D target location, and determining said 3D source location and said 3D target location from those lines.

Preferably, then, each line is represented in Plücker coordinates as a pair of 3D vectors (d,m), and wherein determining the 3D source location (Pᵢ), in the 3D scene, of which the 2D source location (pᵢ^{j}) is the projection into the corresponding view, comprises solving the system of equations formed by the initial set of positional constraints, in the least squares sense:

$${\hat{P}}_{1} = {Argmin}_{{P}_{i}} {\sum }_{j} {‖ {P}_{i} {d}_{i}^{j} - {m}_{i}^{j} ‖}^{2}$$

A method according to this embodiment allows minimizing the errors of projection of the 3D scene into the 2D views, due to potential calibration data imprecision, when determining the 3D locations of the source point and target point.

In one particular embodiment, determining the 3D source location (Pᵢ) and the 3D target location (Qᵢ), in the 3D scene, of which the 2D source location and the target location respectively are the projections into the corresponding view (Vⱼ), comprises minimizing the following criterion:

( [symbol] , [symbol] , . . . , [symbol] , [symbol] )=Argmin_{({P}_{ᵢ}_{,Q}_{ᵢ}_{})}{ΣᵢΣ_{jϵP}_{ᵢ}[∥PᵢΛdᵢ^{j}−mᵢ^{j}∥²+∥QᵢΛd′ᵢ^{j}−m′ᵢ^{j}∥²]+ΣₖΣ_{l>k}[∥Pₖ−Qₖ∥²−∥Pₗ−Qₗ∥²]}

A method according to this embodiment allows introducing restrictions on the deformation to be applied on the scene points. For instance, one may want to preserve the geometry of the original 3D scene by imposing that the distances between each pair of corresponding 3D source point and target point are as constant as possible.

In one particular embodiment, warping implements a moving least square algorithm.

In one particular embodiment, warping implements a bounded biharmonic weights warping model defined as a function of a set of affine transforms, in which one affine transform is attached to each positional constraint.

In one particular embodiment, the method comprises a prior step of inputting the affine transform for each positional constraint.

In one particular embodiment, the method comprises a prior step of determining the affine transform for each positional constraint by least-squares fitting an affine transform at the location of the point, from all other the positional constraint parameters.

In one particular embodiment, the method comprises rendering at least one of the warped 2D images of the 3D scene.

The invention also pertains to an apparatus for consistently editing light field data, in which:
the light field data comprise a plurality of calibrated 2D images of a 3D scene depicted from a set of 2D views,
the set of 2D views comprises at least two reference views and at least one additional view,
at least one initial set of positional constraint parameters is associated with the at least two reference views, each of the positional constraint parameters representing a transformation to be applied to a given point in an original 2D image of the 3D scene depicted from a corresponding view, among the at least two reference views, to warp said original 2D image, the positional constraint parameters consisting of:
   a 2D source location in the corresponding view, of the given point in the original 2D image of the 3D scene depicted from the corresponding view,
   a 2D target location in the corresponding view, of the given point in a warped 2D image of the 3D scene depicted from the corresponding view,
      said apparatus comprising a processor configured for:
determining for each of the positional constraint parameters associated with the at least two reference views, a 3D source location, in the 3D scene, of which the 2D source location is the projection into the corresponding view, and a 3D target location, in the 3D scene, of which the 2D target location is the projection into the corresponding view,
determining an additional set of additional positional constraint parameters, associated with the at least one additional views, as a function of the 3D source location and the 3D target location, each of the additional positional constraint parameters representing a transformation to be applied to a given point in an original 2D image of the 3D scene depicted from a corresponding view, among the at least one additional view, to warp said original 2D image,
warping each of the 2D images of the 3D scene depicted from the set of 2D views, as a function of the positional constraint parameters associated with the 2D views, to obtain the edited light field data.

One skilled person will understand that the advantages mentioned in relation with the method described here below also apply to an apparatus that comprises a processor configured to implement such a method. Since the purpose of the above-mentioned method is to edit light-field data, without necessarily displaying them, such a method may be implemented on any apparatus comprising a processor configured for processing said method.

In one particular embodiment, the apparatus comprises a Human/Machine interface configured for inputting the at least one initial set of positional constraint parameters.

In one particular embodiment, the apparatus comprises a displaying device to display at least one warped 2D image of the edited light field.

In one embodiment, such an apparatus may be a camera.

In another embodiment, the apparatus may be any output device for presentation of visual information, such as a mobile, a television or a computer monitor.

The invention also pertains to light field capture device comprising the above-mentioned apparatus (in any of its different embodiments).

The invention also pertains to a computer program product downloadable from a communication network and/or recorded on a medium readable by a computer and/or executable by a processor, comprising program code instructions for implementing the above-mentioned method (in any of its different embodiments).

The invention also pertains to a non-transitory computer-readable carrier medium, storing a program which, when executed by a computer or a processor causes the computer or the processor to carry out the above-mentioned method (in any of its different embodiments).

Advantageously, the device comprises means for implementing the steps performed in the method of editing as described above, in any of its various embodiments.

While not explicitly described, the present embodiments may be employed in any combination or sub-combination.

### 4. BRIEF DESCRIPTION OF THE DRAWINGS

The present disclosure can be better understood with reference to the following description and drawings, given by way of example and not limiting the scope of protection, and in which:

FIG. 1 is a schematic representation illustrating the geometric warping of a 3D scene and of the corresponding 2D images,

FIG. 2 is a schematic representation illustrating a camera projection for view Vᵢ,

FIG. 3 is a schematic representation illustrating the projections of three positional constraint parameters in 2D views of a light-field,

FIG. 4 is a flow chart illustrating the successive steps implemented when performing a method according to one embodiments of the invention,

FIG. 5 is a block diagram of an apparatus for editing light field data according to one embodiment of the invention,

The components in the figures are not necessarily to scale, emphasis instead being placed upon illustrating the principles of the disclosure.

### 5. DETAILED DESCRIPTION

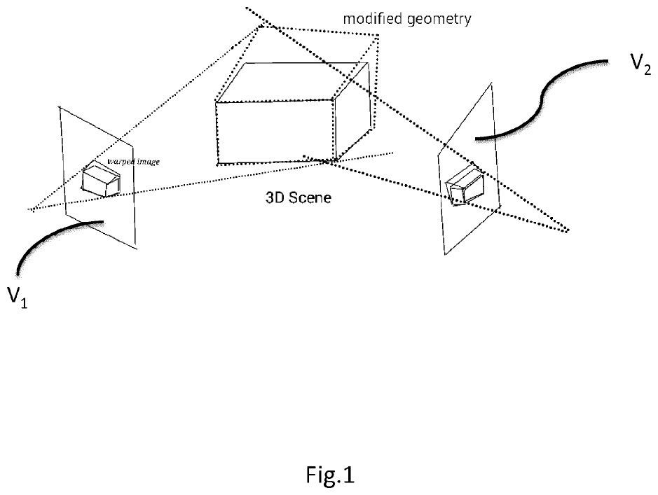

General concepts and specific details of certain embodiments of the disclosure are set forth in the following description and in FIGS. 1 to 5 to provide a thorough understanding of such embodiments. Nevertheless, the present disclosure may have additional embodiments, or may be practiced without several of the details described in the following description.

### 5.1 General Concepts and Prerequisites

The invention describes a method for propagating a geometric warp specified by positional constraints on some of the views of a light-field capture, the reference views, to all the views and generating a warped image for each view, in such a way that the warped images are geometrically consistent in 3D across views.

We assume that the light field is given by a set of views V={Vₘ} which sample the viewing angle under which the scene is captured, as illustrated by FIG. 1.

This set V of views Vₘ comprises at least two reference views Vⱼ and at least one additional view Vₖ.

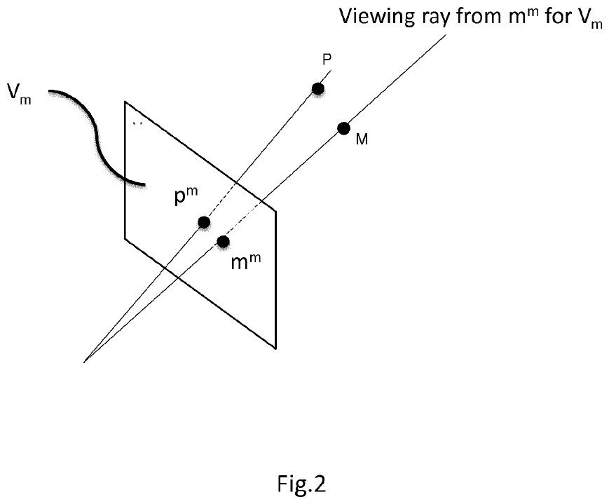

As illustrated by FIG. 2, we further assume that this set V of views is calibrated, meaning that, for each view Vₘ in V, the projection matrix Cₘ for the view is known. Cₘ allows to compute the projection p^{m} into view Vₘ of any point P in 3D space as p^{m}=CₘP. Conversely, given some point m^{m} on the image of view Vₘ, Cₘ allows to compute the viewing ray from m^{m} for view Vₘ, i.e. the line of all points M in 3D space that project onto m^{m} in view Vₘ.

There are several ways, known from the state of art, to compute the camera projection matrices for the views, a process known as calibration.

A first approach to camera calibration is to place an object in the scene with easily detectable points of interest, such as the corners of the squares in a checkerboard pattern, and with known 3D geometry. The detectability of the points of interest in the calibration object allows to robustly and accurately find their 2D projections on each camera view. From these correspondences and the accurate knowledge of the 3D relative positions of the points of interest, the parameters of the intrinsic and extrinsic camera models can be computed by a data fitting procedure. An example of this family of methods is described in the article “A Versatile Camera Calibration Technique for High-Accuracy 3D Machine Vision Metrology Using Off-The-Shelf TV Cameras and Lenses,” by R. Tsai, IEEE Journal on Robotics and Automation, Vols. RA-3, no. 4, pp. 323-344, 1987.

A second approach to camera calibration takes as input a set of 2D point correspondences between pairs of views, i.e., pairs of points (pᵢ^{j},pᵢ^{k}) such that pᵢ^{j} in view Vⱼ and pᵢ^{k} in view Vₖ are the projections of the same 3D scene point Pᵢ. It is well known from the literature, as illustrated by the article “A Robust Technique for Matching Two Uncalibrated Images Through the Recovery of the Unknown Epipolar Geometry”, by Z. Zhang, R. Deriche, O. Faugeras and n. Q.-T. Luo, Artificial Intelligence, vol. 78, no. 1-2, pp. 87-119, 1995, that the fundamental matrix for the pair of views can be computed if at least 8 (eight) such matches are known. Given the projection m^{m} of some 3D scene point M in view Vₘ, the fundamental matrix defines the epipolar line for m^{m} in view Vₙ where the projection of M in this view must lie. Assuming the intrinsic camera parameters are known, either from the camera specifications or from a dedicated calibration procedure, the camera projection matrices for the considered pair of cameras can be computed from an SVD decomposition of the fundamental matrix, as explained in section 9 of the book “Multiple View Geometry in Computer Vision” by R. Hartley and A. Zisserman, Cambridge University Press Ed., 2003.

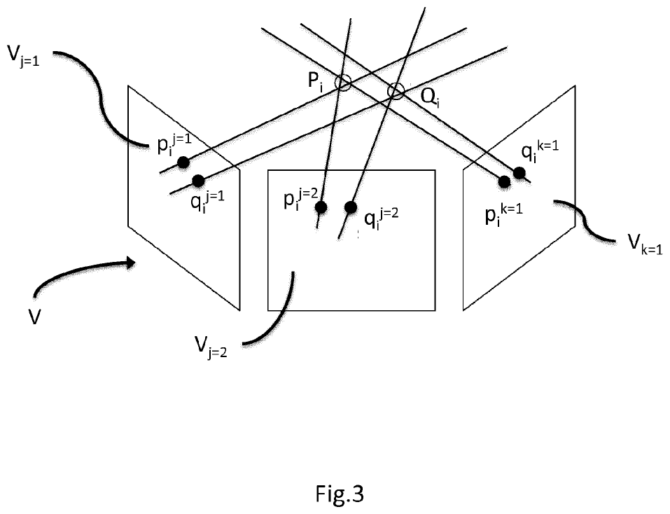

As illustrated by FIG. 3, input data also comprise an initial set Sin, of positional constraint parameters (pᵢ^{j},qᵢ^{j}) each comprising the locations of the projections on a reference view Vⱼ of a source point Pᵢ in the original 3D scene, and of the corresponding target point location Qᵢ in the warped 3D scene. Each of such constraint parameter (pᵢ^{j},qᵢ^{j}) is specified manually by the user in at least two reference views Vⱼ. It is to be noted the set S_{add} of the constraint parameters (pᵢ^{k},qᵢ^{k}), representing the geometrical transformation to be applied to the projections of the same 3D source point Pᵢ and 3D target point Qᵢ in at least one additional view Vₖ, is not part of the input data. In FIG. 3, for the sake of illustration, the reference views are noted (Vⱼ₌₁, Vⱼ₌₂) and the additional view is noted (Vₖ₌₃). The constraint parameters (pᵢ^{j},qᵢ^{j}) provided in reference views Vⱼ represent the geometrical transformations to be applied to the corresponding 3D points of the captured scene, by means of their projections in the reference views Vⱼ. Based on these corresponding 3D points, the method disclosed in this invention first determines the set S_{add} of the constraint parameters (pᵢ^{k},qᵢ^{k}). Following this step, the constraint parameters (pᵢ^{j},qᵢ^{j}) of the reference views Vⱼ, complemented with the constraint parameters (pᵢ^{k},qᵢ^{k}) of the additional views Vₖ, form the constraint parameters (pᵢ^{m},qᵢ^{m}) to be applied to each of the views Vₘ. The method then computes a set of image warping transforms, one for each view Vₘ, which consistently warps the view images across the set V of views Vₘ, in accordance with their respective constraint parameters (pᵢ^{m},qᵢ^{m}).

### 5.2 Method for Consistently Editing Light-Field Data According to One Particular Embodiment

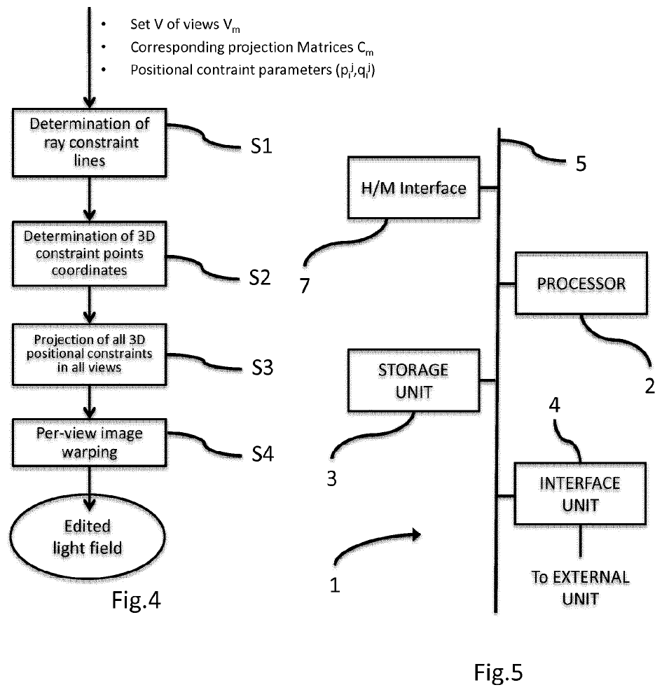

As illustrated by FIG. 4, the method for editing light-field data according to one particular embodiment comprises at least 4 (four) steps:
determining (S1), for each of the input positional constraint parameters (pᵢ^{j}, qᵢ^{j}) in the at least two reference views (Vⱼ), the line in 3D space that projects on the 2D source location (pᵢ^{j}), and the line of 3D space that projects on the 2D target location (40,
determining (S2) the 3D source location (Pᵢ), in the 3D scene, of which the 2D source location (pᵢ^{j}) is the projection into the corresponding view (Vⱼ), and the 3D source location (Qᵢ), in the 3D scene, of which the 2D target location (qᵢ^{j}) is the projection into the corresponding view (Vᵢ),
determining (S3) a set S_{add} of additional positional constraint parameters (pᵢ^{k},qᵢ^{k}), associated with the at least one additional views (Vₖ), as a function of the 3D source location (Pᵢ) and the 3D target location (Qᵢ), each of the pairs (pᵢ^{k},qᵢ^{k}) representing the projections of respectively Pᵢ and Qᵢ in the at least one additional view Vₖ and providing an additional positional constraint to warp said view,
warping (S4) each of the 2D images of the 3D scene depicted from the set of 2D views (Vₘ), as a function of their corresponding positional constraint parameters (pᵢ^{m}, qᵢ^{m}), to obtain the edited light field data.

Each of these stages is described in greater detail below.

Step S1: Generation of Ray Lines for 3D Scene Points Corresponding to an Initial Set Sᵢₙᵢ of 2D Constraint Parameters (pᵢ^{j},qᵢ^{j})

Any source or target constraint point pᵢ^{j} in a view j defines a line in 3D space on which the 3D scene point Pᵢ of which pᵢ^{j} is the projection must lie. This line constrains the location of Pᵢ in 3D space given its projection pᵢ^{j} in view j. Its equation can be computed from the calibration data available for each view, as assumed in the prerequisites. Specifically, the projection of 3D point Pᵢ onto the image plane of view j can be geometrically modelled by a ray passing through Pᵢ and the optical centre of the view Vⱼ, and intersecting the image plane of the view at pᵢ^{j}. Since the optical center of the view Vⱼ is known from the camera projection matrix Cⱼ, the ray can be easily computed as the line going through this center and Pᵢ.

A line in 3D space can advantageously represented in Plücker coordinates as a pair of 3D vectors (d,m)=((d₁, d₂, d₃), (m₁, m₂, m₃)) satisfying the condition d·m=0. If (dᵢ^{j}, mᵢ^{j}) is the Plücker representation of the line passing through Pᵢ and pᵢ^{j}, then the ray constraint on the location of Pᵢ defined by its projection pᵢ^{j} on view j can be expressed as

PᵢΛdᵢ^{j}−mᵢ^{j}=0.

Step S2: Estimation of the 3D Scene Coordinates (Pᵢ,Qᵢ) from the Constraint Parameters (Pᵢ^{j},qᵢ^{j})

The location of any (source, target) constraint point indexed by i is specified by the user in a set Rᵢ of reference views Vⱼ containing at least 2 (two) reference views. The known location of the projection pᵢ^{j} of the source constraint point Pᵢ in each reference view Vⱼ of Rᵢ defines a set of ray constraints, computed in step S1, for the source scene point Pᵢ of which the pᵢ^{j} are the projections. Similarly, the known location of the projection qᵢ^{j} of the target constraint point Qᵢ in each view Vⱼ of Rᵢ defines a set of ray constraints, computed in step S1, for the target scene point Qᵢ of which the qᵢ^{j} are the projections.

The location of each of the scene points Pᵢ and Qᵢ associated to the constraint points is estimated by solving the system of equations formed by its ray constraints for the set Rᵢ of reference views Vⱼ in the least squares sense:

$$= {Argmin}_{{P}_{i}} {\sum }_{j ∈ {R}_{i}} {‖ {P}_{i} {d}_{i}^{j} - {m}_{i}^{j} ‖}^{2}$$

This system can be solved by standard quadratic programming techniques.

Available priors on the deformation of the scene points can be introduced at this stage. For instance, one may want to preserve the geometry of the original 3D scene by imposing that the distances between each pair of corresponding 3D source point Pᵢ (represented by Plücker coordinates (dᵢ, mᵢ)) and target point Qᵢ (represented by Plücker coordinates (d′ᵢ, m′ᵢ)) be as constant as possible. The estimates of the locations of the scene points associated to the 2D positional constraints must then be performed globally, for instance by minimizing the following criterion:

( [symbol] , [symbol] , . . . , [symbol] , [symbol] )=Argmin_{({P}_{ᵢ}_{,Q}_{ᵢ}_{})}{ΣᵢΣ_{jϵP}_{ᵢ}[∥PᵢΛdᵢ^{j}−mᵢ^{j}∥²+∥QᵢΛd′ᵢ^{j}−m′ᵢ^{j}∥²]+ΣₖΣ_{l>k}[∥Pₖ−Qₖ∥²−∥Pₗ−Qₗ∥²]}

This optimization problem can be performed by standard numerical optimization techniques such as Gauss-Newton minimization, as the derivatives of the function to be minimized with respect to the unknowns are available in closed form.

Step S3: Generation of New Set S_{add} of Positional Constraint Parameters (pᵢ^{k},qᵢ^{k}) in Each Additional View Vₖ

Each of the positional constraints defining the specification of the geometrical warp was initially specified by the user in a subset Rᵢ of the light field views. The 2D projections pᵢ^{k} into any additional view Vₖ in V excluding Rᵢ of each 3D constraint point Pᵢ computed in step S2 can be determined using the view camera projection matrices {Cₖ}, known from the calibration data:

pᵢ^{k}=CₖPᵢ.

Thus, at the output of step S3, the 2D projections (pᵢ^{j},qᵢ^{j}) of the source and target positional constraint parameters, initially specified by the user in subsets Rᵢ of reference views (Vᵢ), are known in all the views.

Step 4: Warping of Each View Vₘ by Applying the Constraint Parameters (pᵢ^{m},qᵢ^{m})

Assume that N different (source Pᵢ, target Qᵢ) positional constraints were initially specified by the user by means of their projections (pᵢ^{j}, qᵢ^{j}) in subsets Rᵢ of reference views. Following step S3, the projections (pᵢ^{j}, qᵢ^{j}) for 1≤i≤N of the positional constraint parameters are now known for all views Vₘ. An optimal warping transformation Mₓ^{m} is then computed, independently in each view Vₘ, for every pixel of the view, based on the projections (pᵢ^{m}, qᵢ^{m}) of the positional constraints in the view.

The computation of Mₓ^{m} may take various forms, depending on the choice of the optimization criterion and the model for the transform. Advantageously, one of the Moving Least Squares energies and associated constrained affine models for Mₓ proposed in the article “Image deformation using moving least squares,” by S. Schaefer, T. McPhail and J. Warren, in SIGGRAPH, 2006, is used to compute Mₓ^{m}. For instance, Mₓ^{m} is chosen to be an affine transform consisting of a linear transformation Aₓ^{m} and a translation Tₓ^{m}:

Mₓ^{m}(x)=Aₓ^{m}x+Tₓ^{m},

and is defined as the solution to the following optimization problem:

$${M}_{x}^{m} = {Argmin}_{M} {\sum }_{i = 1}^{N} \frac{1}{{\vert x - {p}_{i}^{m} \vert}^{2}} {\vert M ( {p}_{i}^{m} ) - {q}_{i}^{m} \vert}^{2}$$

for every point x different from a pᵢ^{m}. Mₚᵢₘ (pᵢ^{m}) is defined to be equal to qᵢ^{m}. The minimization of the right term in the above equation is a quadratic programming problem whose solution can be obtained using techniques well known from the state of art.

The invention is not limited to the above choice of warping model and optimality criterion. For example, the bounded biharmonic weights warping model proposed in the article “Bounded Biharmonic Weights for Real-Time Deformation,” A. Jacobson, I. Baran, J. Popovic and O. Sorkine, in SIGGRAPH, 2011, could be used in place of the moving least squares algorithm. In this approach, an affine transform over the whole image is associated to each user-specified positional constraint, and the image warp is computed as a linear combination of these affine transforms. The optimal warping transformation is defined as the one for which the weights of the linear combination are as constant as possible over the image, subject to several constraints. In particular, the warp at the location of each positional constraint is forced to coincide with the affine transform associated to the constraint. The resulting optimization problem is discretized using finite element modelling and solved using sparse quadratic programming.

The biharmonic warping model needs an affine transform to be specified at the location of each positional constraint. A first option is to restrict this affine transform to the specified translation from the source to the target constraint point. Alternatively, the affine transform could be computed by least-squares fitting an affine transform for the considered location, using all other available positional constraints as constraints for the fitting.

### 5.3 Description of an Apparatus for Consistently Editing Light-Field Data.

FIG. 5 is a schematic block diagram illustrating an example of an apparatus 1 for editing light-field data, according to one embodiment of the present disclosure. Such an apparatus 1 includes a processor 2, a storage unit 3 and an interface unit 4, which are connected by a bus 5. Of course, constituent elements of the computer apparatus 1 may be connected by a connection other than a bus connection using the bus 5.

The processor 2 controls operations of the apparatus 1. The storage unit 3 stores at least one program to be executed by the processor 2, and various data, including light-field data, parameters used by computations performed by the processor 2, intermediate data of computations performed by the processor 2, and so on. The processor 2 may be formed by any known and suitable hardware, or software, or by a combination of hardware and software. For example, the processor 2 may be formed by dedicated hardware such as a processing circuit, or by a programmable processing unit such as a CPU (Central Processing Unit) that executes a program stored in a memory thereof.

The storage unit 3 may be formed by any suitable storage or means capable of storing the program, data, or the like in a computer-readable manner. Examples of the storage unit 3 include non-transitory computer-readable storage media such as semiconductor memory devices, and magnetic, optical, or magneto-optical recording media loaded into a read and write unit. The program causes the processor 2 to perform a process for editing light-field data, according to an embodiment of the present disclosure as described above with reference to FIG. 4.

The interface unit 4 provides an interface between the apparatus 1 and an external apparatus. The interface unit 4 may be in communication with the external apparatus via cable or wireless communication. In this embodiment, the external apparatus may be a light field-capturing device 6. In this case, light-field data can be input from the plenoptic camera to the apparatus 1 through the interface unit 4, and then stored in the storage unit 3.

The apparatus 1 and the plenoptic camera may communicate with each other via cable or wireless communication.

The apparatus 1 may comprise a displaying device or be integrated into any display device for displaying one or several of the warped 2D images.

The apparatus 1 may also comprise a Human/Machine Interface 7 configured for allowing a user inputting the at least one initial set Sᵢₙᵢ of positional constraint parameters (pᵢ^{j}, qᵢ^{j}).

Although only one processor 2 is shown on FIG. 5, a skilled person will understand that such a processor may comprise different modules and units embodying the functions carried out by the apparatus 1 according to embodiments of the present disclosure, such as:
A module for determining (S1), for each of the input positional constraint parameters (pᵢ^{j}, qᵢ^{j}) in the at least two reference views Vⱼ, the line in 3D space that projects on the 2D source location pᵢ^{j}, and the line in the 3D space that projects on the 2D target location qᵢ^{j},
A module for determining (S2) the 3D source location Pᵢ, in the 3D scene, of which the 2D source location pᵢ^{j} is the projection into the corresponding view Vⱼ, and the 3D target location Qᵢ, in the 3D scene, of which the 2D target location qᵢ^{j} is the projection into the corresponding view Vⱼ,
A module for determining (S3) a set of additional positional constraint parameters (pᵢ^{k}, qᵢ^{k}), associated with at least one additional view Vₖ, as a function of each 3D source location Pᵢ and each 3D source location Qᵢ, each of the pairs (pᵢ^{k},qᵢ^{k}) representing the projections of respectively Pᵢ and Qᵢ in the at least one additional view Vₖ and providing an additional positional constraint to warp said view,
A module for warping (S4) each of the 2D images of the 3D scene depicted from the set of 2D views Vₘ, as a function of their corresponding positional constraint parameters (pᵢ^{m}, qᵢ^{m}), to obtain the edited light field data.

These modules may also be embodied in several processors 2 communicating and co-operating with each other.

As will be appreciated by one skilled in the art, aspects of the present principles can be embodied as a system, method or computer readable medium. Accordingly, aspects of the present principles can take the form of an entirely hardware embodiment, an entirely software embodiment (including firmware, resident software, microcode, and so forth), or an embodiment combining software and hardware aspects.

When the present principles are implemented by one or several hardware components, it can be noted that a hardware component comprises a processor that is an integrated circuit such as a central processing unit, and/or a microprocessor, and/or an Application-specific integrated circuit (ASIC), and/or an Application-specific instruction-set processor (ASIP), and/or a graphics processing unit (GPU), and/or a physics processing unit (PPU), and/or a digital signal processor (DSP), and/or an image processor, and/or a coprocessor, and/or a floating-point unit, and/or a network processor, and/or an audio processor, and/or a multi-core processor. Moreover, the hardware component can also comprise a baseband processor (comprising for example memory units, and a firmware) and/or radio electronic circuits (that can comprise antennas), which receive or transmit radio signals. In one embodiment, the hardware component is compliant with one or more standards such as ISO/IEC 18092/ECMA-340, ISO/IEC 21481/ECMA-352, GSMA, StoLPaN, ETSI/SCP (Smart Card Platform), GlobalPlatform (i.e. a secure element). In a variant, the hardware component is a Radio-frequency identification (RFID) tag. In one embodiment, a hardware component comprises circuits that enable Bluetooth communications, and/or Wi-fi communications, and/or Zigbee communications, and/or USB communications and/or Firewire communications and/or NFC (for Near Field) communications.

Furthermore, aspects of the present principles can take the form of a computer readable storage medium. Any combination of one or more computer readable storage medium(s) may be utilized.

Thus for example, it will be appreciated that any flow charts, flow diagrams, state transition diagrams, pseudo code, and the like represent various processes which may be substantially represented in computer readable storage media and so executed by a computer or a processor, whether or not such computer or processor is explicitly shown.

Although the present disclosure has been described with reference to one or more examples, a skilled person will recognize that changes may be made in form and detail without departing from the scope of the disclosure and/or the appended claims.

1. Method for consistently editing light field data,
the method comprising:
processing the light field data that comprise a plurality of calibrated 2D images of a 3D scene depicted from a set of 2D views, the set of 2D views comprising at least two reference views and at least one additional view,
processing at least one initial set of positional constraint parameters associated with the at least two reference views, each of the positional constraint parameters representing a transformation to be applied to a given point in an original 2D image of the 3D scene depicted from a corresponding view, among the at least two reference views, to warp said original 2D image, the positional constraint parameters comprising:
a 2D source location in the corresponding view, of the given point in the original 2D image of the 3D scene depicted from the corresponding view,
a 2D target location in the corresponding view, of the given point in a warped 2D image of the 3D scene depicted from the corresponding view, the method comprising:
determining for each of the positional constraint parameters associated with the at least two reference views, a 3D source location, in the 3D scene, of which the 2D source location is the projection into the corresponding view and a 3D target location, in the 3D scene, of which the 2D target location is the projection into the corresponding view,
determining an additional set of additional positional constraint parameters, associated with the at least one additional views, as a function of the 3D source location and the 3D target location, each of the additional positional constraint parameters representing a transformation to be applied to a given point in an original 2D image of the 3D scene depicted from a corresponding view, among the at least one additional view, to warp said original 2D image,
warping each of the 2D images of the 3D scene depicted from the set of 2D views, as a function of the positional constraint parameters associated with said 2D views, to obtain the edited light field data.

2. The method of claim 1, wherein said plurality of calibrated 2D images of the 3D scene is further depicted from a set of corresponding matrices of projection of the 3D scene for each of the 2D views.

3. The method of claim 1, wherein it comprises a prior step of inputting the at least one initial set of positional constraint parameters.

4. The method of claim 1, wherein it comprises determining, for each of the positional constraint parameters associated with the at least two reference views, a line in 3D space that projects on the 2D source location, and a line in 3D space that projects on the 2D target location, and determining said 3D source location and said 3D target location from said lines.

5. The method of claim 4, wherein each line is represented in Plücker coordinates as a pair of 3D vectors noted (d,m), and wherein determining the 3D source location (Pᵢ), in the 3D scene, of which the 2D source location (pᵢ^{j}) is the projection into the corresponding view (Vⱼ), comprises solving the system of equations formed by the initial set of positional constraints (pᵢ^{j},qᵢ^{j}), in the least squares sense:
\hat{P}ᵢ=Argmin_{P}_{ᵢ}Σⱼ∥PᵢΛdᵢ^{j}−mᵢ^{j}∥².

6. The method of claim 1, wherein warping implements a moving least square algorithm.

7. The method of claim 1, wherein warping implements a bounded biharmonic weights warping model defined as a function of a set of affine transforms, in which one affine transform is attached to each positional constraint.

8. The method of claim 7, wherein it comprises a prior step of inputting the affine transform for each positional constraint.

9. The method of claim 7, wherein it comprises a prior step of determining the affine transform for each positional constraint by least-squares fitting an affine transform at the location of the point, from all other the positional constraint parameters.

10. The method of any of claim 1, wherein it comprises rendering at least one of the warped 2D images of the 3D scene.

11. An apparatus (1) for consistently editing light field data, in which:
the light field data comprise a plurality of calibrated 2D images of a 3D scene depicted from a set of 2D views, the set of 2D views comprising at least two reference views and at least one additional view,
at least one initial set of positional constraint parameters is associated with the at least two reference views, each of the positional constraint parameters representing a transformation to be applied to a given point in an original 2D image of the 3D scene depicted from a corresponding view, among the at least two reference views, to warp said original 2D image, the positional constraint parameters consisting of:
a 2D source location in the corresponding view, of the given point in the original 2D image of the 3D scene depicted from the corresponding view,
a 2D target location in the corresponding view, of the given point in a warped 2D image of the 3D scene depicted from the corresponding view,
said apparatus comprising a processor configured for:
determining for each of the positional constraint parameters associated with the at least two reference views, a 3D source location, in the 3D scene, of which the 2D source location is the projection into the corresponding view, and a 3D target location, in the 3D scene, of which the 2D target location is the projection into the corresponding view,
determining an additional set of additional positional constraint parameters, associated with the at least one additional views, as a function of the 3D source location and the 3D source location, each of the additional positional constraint parameters representing a transformation to be applied to a given point in an original 2D image of the 3D scene depicted from a corresponding view, among the at least one additional view, to warp said original 2D image,
warping each of the 2D images of the 3D scene depicted from the set of 2D views, as a function of the positional constraint parameters associated with said 2D views, to obtain the edited light field data.

12. The apparatus of claim 11, wherein it comprises a Human/Machine interface configured for inputting the at least one initial set of positional constraint parameters.

13. The apparatus of claim 11, comprising a displaying device to display at least one warped 2D image of the edited light field.

14. The apparatus of claim 11 wherein said apparatus belongs to a set comprising a light field capture device.

15. A computer program product downloadable from a communication network and/or recorded on a medium readable by a computer and/or executable by a processor, comprising program code instructions for implementing a method according to claim 1.
